(19) United States
(12) Patent Application Publication
(10) Pub. No.: US 2026/0316693 A1
(43) Pub. Date: Oct. 15, 2026

(54) VEHICLE-MOUNTED WIRELESS CHARGING HOLDER

(71) Applicant: SHENZHEN MGCTECH CO., LTD., Shenzhen (CN)

(72) Inventor: Jiedan LI, Shenzhen (CN)

(73) Assignee: SHENZHEN MGCTECH CO., LTD., Shenzhen (CN)

(21) Appl. No.: 19/213,975

(22) Filed: May 20, 2025

(30) Foreign Application Priority Data
Apr. 10, 2025 (CN) 202520670366.3

(51) Int. Cl. B60R 11/02; B60R 11/00; H02J 7/00; H02J 50/00

(52) U.S. Cl. CPC B60R 11/0241; H02J 7/731; H02J 50/005; B60R 2011/0005; B60R 2011/0059; B60R 2011/0071; B60R 2011/0089

(57) ABSTRACT

Disclosed is a vehicle-mounted wireless charging holder, including a holder assembly and a wireless charging assembly. The holder assembly includes a housing, a first clamping assembly, and a second clamping assembly, the first clamping assembly and the second clamping assembly are slidably and telescopically arranged on two opposite sides of the housing respectively, a clamping position for clamping an electronic device is formed between the first clamping assembly and the second clamping assembly, the housing is provided with a first connecting structure, the first connecting structure is located in the clamping position, the wireless charging assembly is provided with a second connecting structure, and the first connecting structure and the second connecting structure are detachably connected.

### RELATED APPLICATIONS

This application claims the benefit of priority of Chinese application number 202520670366.3, filed on Apr. 10, 2025. The entire contents of the above-mentioned applications are incorporated herein by reference.

### TECHNICAL FIELD

The present disclosure relates to the technical field of a vehicle-mounted holder, and in particular, to a vehicle-mounted wireless charging holder.

### BACKGROUND

A vehicle-mounted wireless charging holder is installed at a desktop, an automobile center console, and the like, and configured to clamp and support an electronic device. With the diversified development of mobile phone charging methods, both wired and wireless charging modes have emerged. For the wireless charging mode, a wireless charger needs to be configured for the mobile phone. To simultaneously support and charge the mobile phone, a mobile phone holder with a built-in wireless charger is provided in the prior art. Since the wireless charger is integrated inside the mobile phone holder, the mobile phone is necessarily clamped onto the mobile phone holder during charging. However, for some mobile phones that do not support wireless charging, the wireless charger inside the mobile phone holder cannot implement the charging function. Since the wireless charger cannot be removed from the mobile phone holder for standalone use during operation, the wireless charging mobile phone holder can only adapt to one mobile phone, and fails to meet user needs and market demands.

### SUMMARY

A purpose of the present disclosure is to provide a vehicle-mounted wireless charging holder, to solve the technical problem in the prior art that a wireless charger on the vehicle-mounted wireless charging holder cannot be removed for standalone use.

The present disclosure provides a vehicle-mounted wireless charging holder, which includes a holder assembly and a wireless charging assembly, where the holder assembly includes a housing, a first clamping assembly, and a second clamping assembly, the first clamping assembly and the second clamping assembly are slidably and telescopically arranged on two opposite sides of the housing respectively, a clamping position for clamping an electronic device is formed between the first clamping assembly and the second clamping assembly, the housing is provided with a first connecting structure, the first connecting structure is located in the clamping position, the wireless charging assembly is provided with a second connecting structure, and the first connecting structure and the second connecting structure are detachably connected.

In the vehicle-mounted wireless charging holder as mentioned above, the first connecting structure is arranged on one side wall, facing the clamping position, of the housing, the wireless charging assembly includes a front shell and a rear shell, the front shell is provided with a wireless charging surface, and the second connecting structure is arranged on the rear shell.

In the vehicle-mounted wireless charging holder as mentioned above, the housing includes a bottom shell, a first top shell, and a second top shell, a rear end of the first top shell is connected with the bottom shell, a rear end of the second top shell is connected with a front end of the first top shell to form a second inner cavity, the first connecting structure includes at least one first magnetic block, and the first magnetic block is arranged in the second inner cavity.

In the vehicle-mounted wireless charging holder as mentioned above, the second connecting structure includes at least one second magnetic block, the second magnetic block is arranged on one side wall, facing away from the housing, of the rear shell, and the second magnetic block corresponds to the first magnetic block.

In the vehicle-mounted wireless charging holder as mentioned above, a number of the first magnetic blocks and a number of the second magnetic blocks are both plural, a plurality of second magnetic blocks are distributed around the rear shell, the number of the first magnetic blocks is the same as the number of the second magnetic blocks, and each of the first magnetic blocks corresponds to one of the second magnetic blocks.

In the vehicle-mounted wireless charging holder as mentioned above, the vehicle-mounted wireless charging holder includes a gear structure, the housing is provided with a first inner cavity, the gear structure is rotatably arranged on an inner wall of the first inner cavity, at least part of the first clamping assembly extends into the first inner cavity to be engaged with the gear structure, and at least part of the second clamping assembly extends into the first inner cavity to be engaged with the gear structure.

In the vehicle-mounted wireless charging holder as mentioned above, the first clamping assembly includes a first clamping arm and a first connecting rod, one end of the first connecting rod is connected with the first clamping arm, and the other end of the first connecting rod extends into the first inner cavity to be engaged with the gear structure.

In the vehicle-mounted wireless charging holder as mentioned above, the second clamping assembly includes a second clamping arm, a third clamping arm, a second connecting rod, and a third connecting rod, one end of the second connecting rod is connected with the second clamping arm, the other end of the second connecting rod extends into the first inner cavity to be engaged with the gear structure, one end of the third connecting rod is connected with the third clamping arm, the other end of the third connecting rod extends into the first inner cavity to be engaged with the gear structure, and the second clamping arm and the third clamping arm are arranged on two adjacent corners of the housing respectively.

In the vehicle-mounted wireless charging holder as mentioned above, the gear structure includes a driving gear and a driven gear, the driven gear and the driving gear are engaged with each other, the first connecting rod, the second connecting rod, and the third connecting rod are all engaged with the driving gear, a locking structure is rotatably arranged on the housing, and when the locking structure rotates to a first position, the locking structure is engaged with the driven gear to restrict rotation of the driven gear; and when the locking structure rotates to a second position, the locking structure is separated from the driven gear.

In the vehicle-mounted wireless charging holder as mentioned above, the vehicle-mounted wireless charging holder includes a vehicle pipe clamping assembly for fixing the holder assembly onto a vehicle, the vehicle pipe clamping assembly includes a first arc clamping arm, a second arc clamping arm, and an adjusting structure, the first arc clamping arm is provided with a universal rotating rod, the universal rotating rod is rotatably connected with the housing, the first arc clamping arm and the second arc clamping arm are rotatably connected, the adjusting structure runs through the first arc clamping arm and the second arc clamping arm and is configured to adjust an opening angle between the first arc clamping arm and the second arc clamping arm.

The embodiments of the present disclosure have the following beneficial effects.

In the present disclosure, the vehicle-mounted wireless charging holder includes the holder assembly and the wireless charging assembly, where the holder assembly includes the housing, the first clamping assembly, and the second clamping assembly, the first clamping assembly and the second clamping assembly are slidably and telescopically arranged on two opposite sides of the housing respectively, the clamping position for clamping the electronic device is formed between the first clamping assembly and the second clamping assembly, the housing is provided with the first connecting structure, the first connecting structure is located in the clamping position, the wireless charging assembly is provided with the second connecting structure, and the first connecting structure and the second connecting structure are detachably connected. The holder assembly is configured to clamp the electronic device to support and fix the electronic device; the wireless charging assembly is configured to charge the electronic device; and the holder assembly and the wireless charging assembly are configured as two detachable modular structures, and the wireless charging assembly may be combined with the holder assembly for use, or may be detached from the holder assembly to independently serve as a mobile power, so that the electronic devices that do not need to be clamped can be charged, and diverse application requirements of users can be met. When one module is damaged, only the damaged module needs to be replaced or repaired, rather than replacing or repairing the whole vehicle-mounted wireless charging holder, so that the application cost can be reduced.

### BRIEF DESCRIPTION OF THE DRAWINGS

To more clearly describe the technical solutions in the embodiments of the present disclosure or in the prior art, the drawings required to be used in the description of the embodiments or in the prior art are simply presented below. Apparently, the following drawings show some embodiments of the present disclosure, so for those ordinary skilled in the art, other drawings can also be obtained according to these drawings without contributing creative labor.

FIG. 1 is a schematic structural diagram of a vehicle-mounted wireless charging holder according to an exemplary embodiment.

FIG. 2 is a schematic structural diagram of a vehicle-mounted wireless charging holder from another viewing angle according to an exemplary embodiment.

FIG. 3 is a schematic structural diagram of separation of a holder assembly from a wireless charging assembly according to an exemplary embodiment.

FIG. 4 is a structural exploded view of a vehicle-mounted wireless charging holder according to an exemplary embodiment.

FIG. 5 is a schematic diagram of an internal structure of a holder assembly according to an exemplary embodiment.

FIG. 6 is a schematic structural diagram of a connection of a first clamping assembly, a second clamping assembly, a locking structure, and a gear structure according to an exemplary embodiment.

FIG. 7 is a schematic structural diagram of a connection between a bottom shell and a gear structure according to an exemplary embodiment.

FIG. 8 is a schematic structural diagram of a locking member according to an exemplary embodiment.

In the drawings: 1, housing; 11, bottom shell; 111, rotating hole; 1111, limiting hole; 112, limiting ball; 113, first limiting guide pillar; 114, second limiting guide pillar; 115, third limiting guide pillar; 116, connecting block; 12, first top shell; 13, second top shell; 131, air guide slot; 14, first magnetic block; 2, wireless charging assembly; 21, front shell; 22, rear shell; 23, second magnetic block; 3, gear structure; 31, driving gear; 32, driven gear; 4, first clamping assembly; 41, first clamping arm; 411, first bottom support arm; 412, second bottom support arm; 42, first connecting rod, 421, first limiting guide slot; 422, connecting hole; 423, elastic member; 5, second clamping assembly; 51, second clamping arm; 52, third clamping arm; 53, second connecting rod; 531, second limiting guide slot; 54, third connecting rod; 541, third limiting guide slot; 6, vehicle pipe clamping assembly; 61, first arc clamping arm; 62, second arc clamping arm; 63, adjusting rod; 64, adjusting member; 7, locking structure; 71, driving member; 72, locking member; 721, limiting pillar; 8, flexible rubber corner pad; and 9, anti-slip flexible rubber pad.

### DETAILED DESCRIPTION

Technical solutions in embodiments of the present disclosure are clearly and completely described in combination with accompanying drawings in embodiments of the present disclosure. Apparently, the described embodiments are merely some embodiments of the present disclosure, not all embodiments. All other embodiments obtained by a person of the ordinary skilled in the art based on the embodiments of the present disclosure without creative efforts shall fall within the scope of protection of the present disclosure.

In the description of the present disclosure, it should be noted that the terms “center”, “longitudinal”, “horizontal”, “length”, “width”, “thickness”, “upper,” “lower,” “front,” “rear,” “left,” “right”, “vertical”, “horizontal”, “top”, “bottom”, “inside”, “outside”, “clockwise”, “counterclockwise” and the like indicating the orientation or positional relationship are based on the orientation or positional relationship shown in the drawings, and are only used for convenience in describing the present disclosure and simplifying the description, rather than indicating or implying that specific devices or elements must have a specific orientation and be constructed and operated in a specific orientation. Therefore, the terms cannot be understood as limitations to the present disclosure.

In addition, terms “first” and “second” are only for the purpose of description, and cannot be understood as indicating or implying relative importance or implicitly indicating the number of indicated technical features. Therefore, features defined with “first” and “second” may explicitly or implicitly include one or more of the features. In the description of the present disclosure, “a plurality of” means two or more, unless otherwise specified.

In present disclosure, unless otherwise clearly defined and limited, the terms “mount”, “connected”, “connection” and “fixed” should be understood in a broad sense, for example, it can be a fixed connection, a detachable connection, or an integral connection; it can be a mechanical connection or an electrical connection; and it can be a direct connection or an indirect connection through an intermediate medium, and can also be a communication of two elements or an interaction relationship of two elements. For those ordinary skilled in the art, the specific meaning of the above terms in the present disclosure may be understood in specific circumstances.

Unless otherwise defined, meanings of all technical and scientific terms used in this specification are the same as those usually understood by a person skilled in the art to which the present disclosure belongs. Terms used in the description of the present disclosure are merely intended to describe the purpose of embodiment, but are not intended to limit the present disclosure.

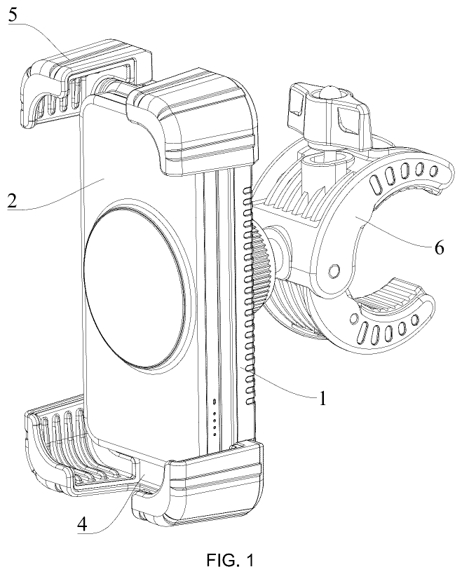

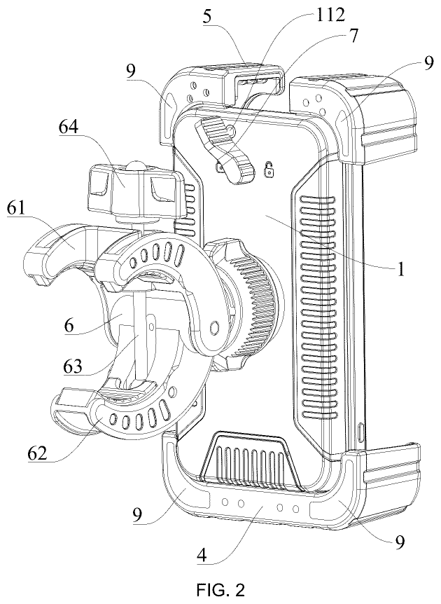

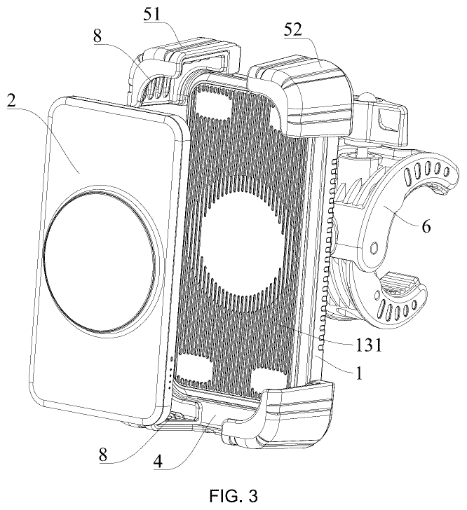

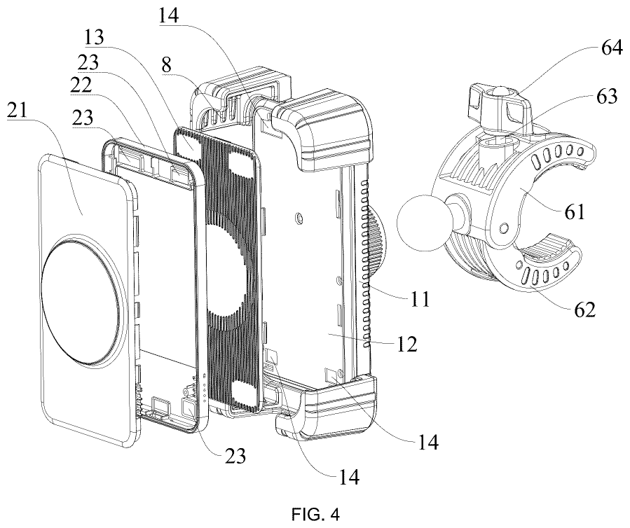

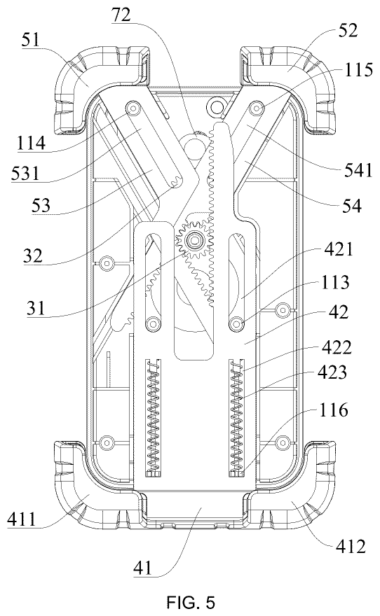

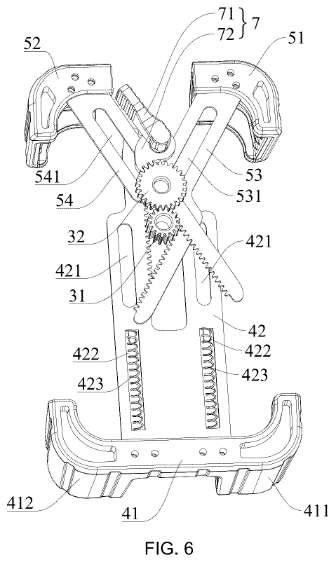

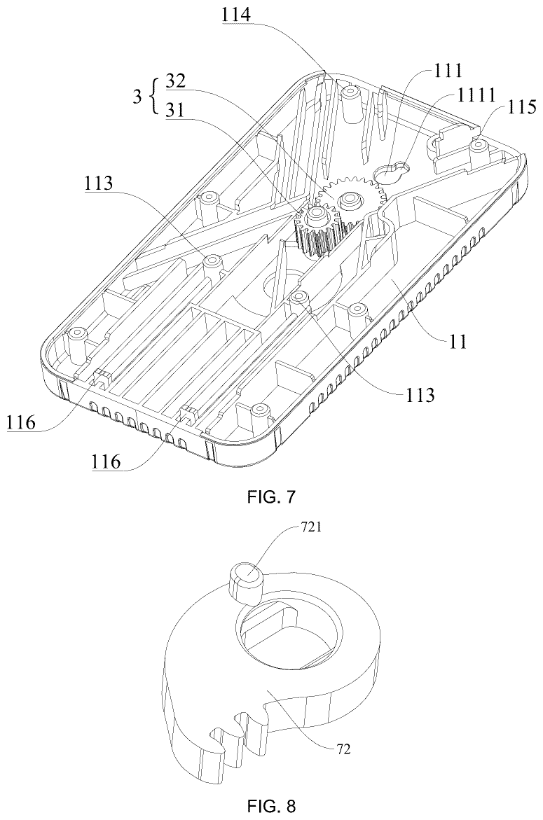

Referring to FIG. 1 to FIG. 8, the present disclosure provides a vehicle-mounted wireless charging holder, which includes a holder assembly and a wireless charging assembly 2, where the holder assembly includes a housing 1, a first clamping assembly 4, and a second clamping assembly 5, the first clamping assembly 4 and the second clamping assembly 5 are slidably and telescopically arranged on two opposite sides of the housing 1 respectively, a clamping position for clamping an electronic device is formed between the first clamping assembly 4 and the second clamping assembly 5, the housing 1 is provided with a first connecting structure, the first connecting structure is located in the clamping position, the wireless charging assembly 2 is provided with a second connecting structure, and the first connecting structure and the second connecting structure are detachably connected.

The holder assembly is configured to clamp an electronic device to support and fix the electronic device, such as clamping a mobile phone or a tablet computer; the wireless charging assembly 2 is configured to charge the electronic device such as a mobile phone, a tablet computer, an earphone, and a watch; the holder assembly and the wireless charging assembly 2 are configured as two detachable modular structures, and the wireless charging assembly 2 may be combined with the holder assembly for use, or may be detached from the holder assembly to independently serve as a mobile power, so that the electronic devices that do not need to be clamped can be charged, and diverse application requirements of users can be met. When one module is damaged, only the damaged module needs to be replaced or repaired, rather than replacing or repairing the whole vehicle-mounted wireless charging holder, so that the application cost can be reduced.

Specifically, when the wireless charging assembly 2 is connected onto the housing 1 through the first connecting structure and the second connecting structure, the electronic device; the electronic device is clamped in the clamping position between the first clamping assembly 4 and the second clamping assembly 5, thereby achieving simultaneously clamping and wireless charging for the electronic device via the wireless charging assembly 2; when the electronic device does not need to be charged, the wireless charging assembly 2 may be removed, and then a wireless charging function of the wireless charging assembly 2 and a clamping function of the holder assembly do not affect each other; and the wireless charging assembly 2 can be arranged externally for standalone use, and the holder assembly can implement the clamping function independently.

Further, the first connecting structure is arranged on one side wall, facing the clamping position, of the housing 1, the wireless charging assembly 2 includes a front shell 21 and a rear shell 22, the front shell 21 is provided with a wireless charging surface, and the second connecting structure is arranged on the rear shell 22. When the first connection structure and the second connection structure are connected, the wireless charging assembly 2 is secured to the holder assembly and located in the clamping position, and in this state, when the electronic device such as the mobile phone or tablet computer is clamped in the clamping position by means of the first clamping assembly 4 and the second clamping assembly 5, the electronic device can be in flush contact with the wireless charging surface of the front shell 21, thereby achieving simultaneous clamping and charging.

In this configuration, the front shell 21 and the rear shell 22 may be two components, and the front shell 21 and the rear shell 22 are assembled to form a housing of the wireless charging assembly 2; and the front shell 21 and rear shell 22 may also constitute a front wall and a rear wall of an integrated housing, and the housing has a hollow structure.

Specifically, the front shell 21 is provided with a through hole communicated with the hollow structure, the wireless charging surface covers the through hole, and a magnet and a coil are arranged in the through hole.

Further, the housing 1 includes a bottom shell 11, a first top shell 12, and a second top shell 13, a rear end of the first top shell 12 is connected with the bottom shell 11, a rear end of the second top shell 13 is connected with a front end of the first top shell 12 to form a second inner cavity, the first connecting structure includes at least one first magnetic block 14, and the first magnetic block 14 is arranged in the second inner cavity. The first top shell 12 is provided with a clamping hole, the second top shell 13 is provided with a clamping block, and the clamping block and the clamping hole are buckled to achieve a fixed connection between the first top shell 12 and the second top shell 13.

A front side wall of the second top shell 13 is provided with a plurality of air guide slots 131, and when the wireless charging assembly 2 is in flush contact with the second top shell 13, the plurality of air guide slots 131 can facilitate heat dissipation for the wireless charging assembly 2, thereby preventing overheating of the wireless charging assembly 2 from affecting the application.

Further, the second connecting structure includes at least one second magnetic block 23, the second magnetic block 23 is arranged on one side wall, facing away from the housing 1, of the rear shell 22, and the second magnetic block 23 corresponds to the first magnetic block 14.

A number of the first magnetic blocks 14 and a number of the second magnetic blocks 23 are both plural, a plurality of second magnetic blocks 23 are distributed around the rear shell 22, the number of the first magnetic blocks 14 is the same as the number of the second magnetic blocks 23, and each of the first magnetic blocks 14 corresponds to one of the second magnetic blocks 23.

In a specific embodiment, both the first magnetic blocks 14 and the second magnetic blocks 23 are provided in quantities of four. The four second magnetic blocks 23 are distributed at four corners of the rear shell 22 of the wireless charging assembly 2, and the four first magnetic blocks 14 are also distributed at four corners of the second inner cavity. Each first magnetic block 14 corresponds to one second magnetic block 23, so that all four corners of the wireless charging assembly 2 can be fixed to the holder assembly via a magnetic structure, the connection between the wireless charging assembly 2 and the holder assembly is firmer, and the wireless charging assembly 2 can be prevented from falling off the holder assembly due to bumping or shaking. In some other embodiments, both the first magnetic blocks 14 and the second magnetic blocks 23 may be provided in quantities such as two, three, five, six, seven, or eight, which may be set according to an actual situation.

Further, the vehicle-mounted wireless charging holder includes a gear structure 3, the housing 1 is provided with a first inner cavity, the gear structure 3 is rotatably arranged on an inner wall of the first inner cavity, at least part of the first clamping assembly 4 extends into the first inner cavity to be engaged with the gear structure 3, and at least part of the second clamping assembly 5 extends into the first inner cavity to be engaged with the gear structure 3.

A cavity formed by connecting the rear end of the first top shell 12 and the bottom shell 11 is the first inner cavity, and both the first clamping assembly 4 and the second clamping assembly 5 slidably extend into or retract from in the first inner cavity.

Further, the first clamping assembly 4 includes a first clamping arm 41 and a first connecting rod 42, one end of the first connecting rod 42 is connected with the first clamping arm 41, and the other end of the first connecting rod 42 extends into the first inner cavity to be engaged with the gear structure 3.

Specifically, both ends of the first clamping arm 41 are respectively provided with a first bottom support arm 411 and a second bottom support arm 412, and the first bottom support arm 411 and the second bottom support arm 412 are respectively arranged on two adjacent corners of the housing 1.

Further, the second clamping assembly 5 includes a second clamping arm 51, a third clamping arm 52, a second connecting rod 53, and a third connecting rod 54, one end of the second connecting rod 53 is connected with the second clamping arm 51, the other end of the second connecting rod 53 extends into the first inner cavity to be engaged with the gear structure 3, one end of the third connecting rod 54 is connected with the third clamping arm 52, the other end of the third connecting rod 54 extends into the first inner cavity to be engaged with the gear structure 3, and the second clamping arm 51 and the third clamping arm 52 are arranged on two adjacent corners of the housing 1 respectively.

Specifically, the first bottom support arm 411, the second bottom support arm 412, the second clamping arm 51, and the third clamping arm 52 are respectively arranged at four corners of the housing 1, inner sides of all the first bottom support arm 411, the second bottom support arm 412, the second clamping arm 51, and the third clamping arm 52 are respectively provided with a flexible rubber corner pad 8, the flexible rubber corner pads 8 are configured to be in contact with the clamped mobile phone or tablet computer, thereby avoiding the damage of the mobile phone or tablet computer when being clamped.

Specifically, a backside of the first bottom support arm 411, a backside of the second bottom support arm 412, a backside of the second clamping arm 51, and a backside of the third clamping arm 52 are all provided with an anti-slip rubber pad 9, which can generate a large frictional force when in contact with a vehicle equipped with the holder assembly, thereby ensuring that the holder assembly remains stable without shifting during riding.

Further, the gear structure 3 includes a driving gear 31 and a driven gear 32, the driven gear 32 and the driving gear 31 are engaged with each other, the first connecting rod 42, the second connecting rod 53, and the third connecting rod 54 are all engaged with the driving gear 31, a locking structure 7 is rotatably arranged on the housing 1, and when the locking structure 7 rotates to a first position, the locking structure 7 is engaged with the driven gear 32 to restrict rotation of the driven gear 32; and when the locking structure 7 rotates to a second position, the locking structure 7 is separated from the driven gear 32.

Specifically, the first connecting rod 42 is provided with at least one connecting hole 422, an inner wall of the bottom shell 11 is provided with a connecting block 116, the connecting block 116 extends into the connecting hole 422, an elastic member 423 is arranged in the connecting hole 422, one end of the elastic member 423 is in abutting connection with an end wall of the connecting hole 422, the other end of the elastic member 423 is in abutting connection with the connecting block 116, when an external force is removed from the first clamping assembly 4, the elastic member 423 can drive the first clamping arm 41 to move towards the housing 1 under the action of own elastic force, so that the first clamping assembly 4 can be elastically restored; and moreover, the first connecting rod 42, the second connecting rod 53, and the third connecting rod 54 are all engaged with the driving gear 31, so that both the second clamping arm 51 and the third clamping arm 52 move towards the housing 1, and during restoration, the first clamping assembly 4 drives the second clamping assembly 5 to be restored synchronously. The elastic member 423 may be a spring or a leaf spring, and preferably a spring.

Specifically, the inner wall of the bottom shell 11 is provided with a first limiting guide pillar 113, a second limiting guide pillar 114, and a third limiting guide pillar 115; the first connecting rod 42, the second connecting rod 53, and the third connecting rod 54 are respectively provided with a first limiting guide slot 421, a second limiting guide slot 531, and a third limiting guide slot 541; the first limiting guide pillar 113 is slidably arranged in the first limiting guide slot 421 to restrict the position of the first connecting rod 42; the second limiting guide pillar 114 is slidably arranged in the second limiting guide slot 531 to restrict the position of the second connecting rod 53; the third limiting guide pillar 115 is slidably arranged in the third limiting guide slot 541 to restrict the position of the third connecting rod 54; and the first limiting guide slot 421, the second limiting guide slot 531, and the third limiting guide slot 541 are all elongated guide slots.

Specifically, the rear end wall of the housing 1 is provided with a rotating hole 111 and a limiting ball 112, the rotating hole 111 is communicated with the first inner cavity, the locking structure 7 includes a driving member 71 and a locking member 72, the driving member 71 is rotatably connected onto the rotating hole 111, one end of the locking member 72 is connected with the driving member 71, the other end of the locking member 72 is engaged with the driven gear 32, and under an action of an external force, the driving member 71 drives the locking member 72 to rotate, causing teeth on the locking member 72 to be disengaged from teeth of the driven gear 32, so that the gear structure 3 is unlocked, and the first clamping assembly 4 and the second clamping assembly 5 are telescopic relative to the housing 1 to adjust a size of the clamping position, and clamp the mobile phone or tablet computer in different sizes; the driving member 71 is provided with a lever, one side wall of the lever abuts against the limiting ball 112, and the driving member 71 can be rotated only by applying a large force on the lever, so that the clamped mobile phone or tablet computer can be prevented from falling due to unlocking by mistake of the locking structure; and one side wall of the rotating hole 111 is provided with a limiting hole 1111, the locking member 72 is provided with a limiting pillar 721, the limiting pillar 721 is inserted into the limiting hole 1111, when the locking member 72 rotates to a first position, the limiting pillar 721 abuts against one end wall of the limiting hole 1111, and when the locking member 72 rotates to a second position, the limiting pillar 721 abuts against the other end wall of the limiting hole 1111, thereby restricting a rotation angle of the locking structure 7.

In a specific embodiment, the limiting ball 112 is a hardware ball, and the bottom of the hardware ball is provided with a spring cooperating with the hardware ball; a spring force causes the limiting ball 112 to protrude from the rear wall of the housing 1 and abut against the lever, forming a mechanical lock; when an external force, such as a manually applied force, exceeds the spring force, the limiting ball 112 is squeezed into a recess on the housing 1, allowing the lever to resume movement; and when the external force is removed, the spring pushes the limiting ball 112 to extend out of the recess again, thereby achieving the positioning of a switch gear for the locking structure 7.

The driven gear 32, the first connecting rod 42, the second connecting rod 53, and the third connecting rod 54 are staggered along a central axis direction of the driving gear 31, so that the driven gear 32, the first connecting rod 42, the second connecting rod 53, and the third connecting rod 54 can be engaged with the driving gear 31 simultaneously, and the driven gear 32, the first connecting rod 42, the second connecting rod 53, and the third connecting rod 54 may not interfere with each other.

Further, the vehicle-mounted wireless charging holder includes a vehicle pipe clamping assembly 6 for fixing the holder assembly to a vehicle, the vehicle pipe clamping assembly 6 includes a first arc clamping arm 61, a second arc clamping arm 62, and an adjusting structure, the first arc clamping arm 61 is provided with a universal rotating rod, the universal rotating rod is rotatably connected with the housing 1, the first arc clamping arm 61 and the second arc clamping arm 62 are rotatably connected, and the adjusting structure runs through the first arc clamping arm 61 and the second arc clamping arm 62 and is configured to adjust an opening angle between the first arc clamping arm 61 and the second arc clamping arm 62.

Specifically, the adjusting structure includes an adjusting rod 63 that is connected with the first arc clamping arm 61 and the second arc clamping arm 62 and a rotating adjusting member 64 that is rotatably connected onto the adjusting rod 63 to adjust the opening angle between the first arc clamping arm 61 and the second arc clamping arm 62. One end of the adjusting rod 63 is connected with the first arc clamping arm 61, the other end of the adjusting rod 63 runs through the second arc clamping arm 62 to be in threaded connection with the rotating adjusting member 64, and the rotating adjusting member 64 rotates on the adjusting rod 63, so that the rotating adjusting member 64 can squeeze the second arc clamping arm 62, a maximum opening angle between the second arc clamping arm 62 and the first arc clamping arm 61 is reduced, a clamping space between the first arc clamping arm 61 and the second arc clamping arm 62 is adjusted to adapt to a handlebar or rearview mirror rod in different sizes, and a clamping force can be adjusted dynamically.

In some other embodiments, the first connecting structure and the second connecting structure may be a spring buckle arranged on the housing and the recess arranged at the backside of the wireless charging assembly, the spring buckle and the recess are buckled to achieve the locking between the wireless charging assembly and the holder assembly; and the housing is also provided with a pressing release key, and the spring buckle may be separated from the recess by pressing the pressing release key, so that the wireless charging assembly is separated from the holder assembly.

In some other embodiments, the first connecting structure and the second connecting structure may also be a sliding chute arranged on the housing and a sliding block arranged at the backside of the wireless charging assembly, the sliding chute may be arranged in a vertical direction or a horizontal direction, a limiting baffle is arranged at the end of the sliding chute, and the wireless charging assembly and the holder assembly are locked by means of a connection between the sliding block and the sliding chute; preferably, the sliding block is made of a polycarbonate material, and by employing the high strength and a large elastic coefficient of the polycarbonate material, the sliding block can be deformed and squeezed to be inserted into or detached from the sliding chute, thereby fixing and disassembling the wireless charging assembly.

The above embodiments are merely used to illustrate the technical solutions of the present disclosure, rather than limiting a scope of protection of the present disclosure.

What is claimed is

1. A vehicle-mounted wireless charging holder, comprising a holder assembly and a wireless charging assembly, wherein the holder assembly comprises a housing, a first clamping assembly, and a second clamping assembly, the first clamping assembly and the second clamping assembly are slidably and telescopically arranged on two opposite sides of the housing respectively, a clamping position for clamping an electronic device is formed between the first clamping assembly and the second clamping assembly, the housing is provided with a first connecting structure, the first connecting structure is located in the clamping position, the wireless charging assembly is provided with a second connecting structure, and the first connecting structure and the second connecting structure are detachably connected.

2. The vehicle-mounted wireless charging holder according to claim 1, wherein the first connecting structure is arranged on one side wall, facing the clamping position, of the housing, the wireless charging assembly comprises a front shell and a rear shell, the front shell is provided with a wireless charging surface, and the second connecting structure is arranged on the rear shell.

3. The vehicle-mounted wireless charging holder according to claim 2, wherein the housing comprises a bottom shell, a first top shell, and a second top shell, a rear end of the first top shell is connected with the bottom shell, a rear end of the second top shell is connected with a front end of the first top shell to form a second inner cavity, the first connecting structure comprises at least one first magnetic block, and the first magnetic block is arranged in the second inner cavity.

4. The vehicle-mounted wireless charging holder according to claim 3, wherein the second connecting structure comprises at least one second magnetic block, the second magnetic block is arranged on one side wall, facing away from the housing, of the rear shell, and the second magnetic block corresponds to the first magnetic block.

5. The vehicle-mounted wireless charging holder according to claim 4, wherein a number of the first magnetic blocks and a number of the second magnetic blocks are both plural, a plurality of second magnetic blocks are distributed around the rear shell, the number of the first magnetic blocks is the same as the number of the second magnetic blocks, and each of the first magnetic blocks corresponds to one of the second magnetic blocks.

6. The vehicle-mounted wireless charging holder according to claim 1, wherein the vehicle-mounted wireless charging holder comprises a gear structure, the housing is provided with a first inner cavity, the gear structure is rotatably arranged on an inner wall of the first inner cavity, at least part of the first clamping assembly extends into the first inner cavity to be engaged with the gear structure, and at least part of the second clamping assembly extends into the first inner cavity to be engaged with the gear structure.

7. The vehicle-mounted wireless charging holder according to claim 6, wherein the first clamping assembly comprises a first clamping arm and a first connecting rod, one end of the first connecting rod is connected with the first clamping arm, and the other end of the first connecting rod extends into the first inner cavity to be engaged with the gear structure.

8. The vehicle-mounted wireless charging holder according to claim 7, wherein the second clamping assembly comprises a second clamping arm, a third clamping arm, a second connecting rod, and a third connecting rod, one end of the second connecting rod is connected with the second clamping arm, the other end of the second connecting rod extends into the first inner cavity to be engaged with the gear structure, one end of the third connecting rod is connected with the third clamping arm, the other end of the third connecting rod extends into the first inner cavity to be engaged with the gear structure, and the second clamping arm and the third clamping arm are arranged on two adjacent corners of the housing respectively.

9. The vehicle-mounted wireless charging holder according to claim 8, wherein the gear structure comprises a driving gear and a driven gear, the driven gear and the driving gear are engaged with each other, the first connecting rod, the second connecting rod, and the third connecting rod are all engaged with the driving gear, a locking structure is rotatably arranged on the housing, and when the locking structure rotates to a first position, the locking structure is engaged with the driven gear to restrict rotation of the driven gear; and when the locking structure rotates to a second position, the locking structure is separated from the driven gear.

10. The vehicle-mounted wireless charging holder according to claim 1, wherein the vehicle-mounted wireless charging holder comprises a vehicle pipe clamping assembly for fixing the holder assembly onto a vehicle, the vehicle pipe clamping assembly comprises a first arc clamping arm, a second arc clamping arm, and an adjusting structure, the first arc clamping arm is provided with a universal rotating rod, the universal rotating rod is rotatably connected with the housing, the first arc clamping arm and the second arc clamping arm are rotatably connected, the adjusting structure runs through the first arc clamping arm and the second arc clamping arm and is configured to adjust an opening angle between the first arc clamping arm and the second arc clamping arm.
